(19) United States
(12) Patent Application Publication
(10) Pub. No.: US 2014/0181584 A1
(43) Pub. Date: Jun. 26, 2014

(54) DEBUGGING SYSTEM OF INTEGRATED CIRCUIT AND DEBUGGING METHOD THEREOF

(71) Applicant: Asmedia Technology Inc., New Taipei City (TW)

(72) Inventors: Wen-Hung PENG, New Taipei City (TW); Ching-Chih LIN, New Taipei City (TW); Hui-Yu TANG, New Taipei City (TW)

(73) Assignee: Asmedia Technology Inc., New Taipei City (TW)

(21) Appl. No.: 14/103,021

(22) Filed: Dec. 11, 2013

(30) Foreign Application Priority Data
Dec. 21, 2012 (CN) 201210559860.X

(51) Int. Cl. G06F 11/26

(52) U.S. Cl. CPC G06F 11/26
USPC 714/25

(57) ABSTRACT

A debugging method of an integrated circuit is disclosed. The debugging method is applied to an integrated circuit and a debugging system. The debugging method includes the following steps: selecting an error event of the integrated circuit; selecting a plurality of observing signals of the integrated circuit; storing values of the observing signals at a time point and embedding values of the observing signals in an observing packet to output the observing packet when the error event happens at the time point; outputting the observing packet and a plurality of data packets of the integrated circuit sequentially according to a priority value table; encoding the observing packet to output a plurality of output signals; and outputting the output signals via a transmission interface of the debugging system.

### CROSS-REFERENCE TO RELATED APPLICATION

This application claims the priority benefit of application serial No. 201210559860.X filed in People's Republic of China on Dec. 21, 2012. The entirety of the above-mentioned patent application is hereby incorporated by reference herein and made a part of specification.

### BACKGROUND OF THE INVENTION

1. Field of the Invention

The disclosure relates to a debugging system and a debugging method and, more particularly, to a debugging system and a debugging method of an integrated circuit.

2. Description of the Related Art

With the development of the electronic industry, integrated circuits (IC) have become main element used to achieve many functional circuits of electronic devices. Due to human errors, process technical problems, or other reasons during the manufacture process, the integrated circuits may cause bugs after the integrated circuits are made so that the functions may be abnormally. Therefore, a debug process is usually operated after the integrated circuits are made to ensure it can normally operate.

Currently, when an integrated circuit is debugged, debugging signals inside the integrated circuit are outputted via a digital I/O connector which is connected with a logical analyzer for easily observing the debugging signals. However, this debugging method needs to add many I/O connecting pins to the integrated circuit for effectively observing the internal behavior of the integrated circuit so that the manufacture cost of the integrated circuit is increased. On the other hand, in order to effectively observe the internal behavior of the integrated circuit without increasing pins of the integrated circuit, a part of the pins should be used for the debugging function instead of the original functions, therefore, the behavior of the integrated circuit is changed and functions of the integrated circuit is reduced.

### BRIEF SUMMARY OF THE INVENTION

An integrated circuit debugging method is disclosed. The debugging method is applied to an integrated circuit and a debugging system. The debugging method includes the following steps: selecting an error event of the integrated circuit; selecting a plurality of observing signals of the integrated circuit; storing values of the observing signals at a time point and embedding values of the observing signals in an observing packet to output the observing packet when the error event happens at the time point; outputting the observing packet and a plurality of data packets of the integrated circuit sequentially according to a priority value table; encoding the observing packet to output a plurality of output signals; and outputting the output signals via a transmission interface of the debugging system.

A debugging system of an integrated circuit is provided. The debugging system is applied to the integrated circuit and includes a debugging trigger multiplexer, a debugging signal multiplexer, a buffer, a differential signal converter, and a transmission interface. The debugging trigger multiplexer is electrically connected with the integrated circuit to detect an error event of the integrated circuit. The debugging signal multiplexer is electrically connected with the integrated circuit to detect the error event of the integrated circuit, choose and output a plurality of observing signals according to the error event. The buffer is electrically connected with the debugging trigger multiplexer and the debugging signal multiplexer to receive the observing signals. The differential signal converter is coupled with the buffer. A transmission interface is electrically connected with the differential signal converter.

These and other features, aspects and advantages of the present disclosure will become better understood with regard to the following description, appended claims, and accompanying drawings.

### BRIEF DESCRIPTION OF THE DRAWINGS

FIG. 1 is a block diagram showing a debugging system of an integrated circuit in an embodiment of the disclosure; and

FIG. 2 is a flow chart showing a debugging method of an integrated circuit in an embodiment.

### DETAILED DESCRIPTION OF THE EMBODIMENTS

A debugging method of an integrated circuit according to an embodiment is described as following, and same symbols refers to same elements.

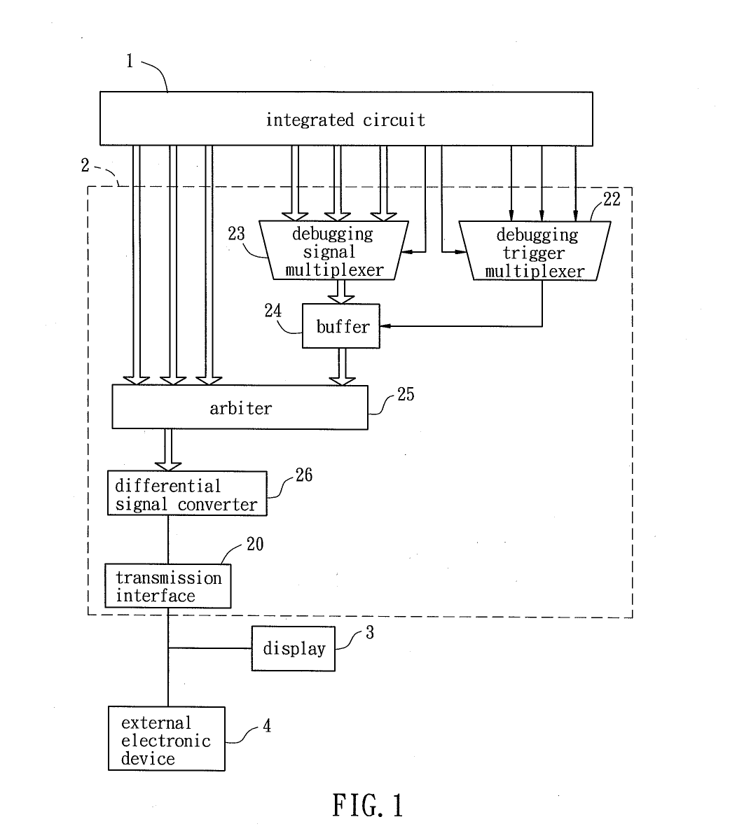

FIG. 1 is a block diagram showing a debugging system of an integrated circuit in an embodiment of the disclosure. A debugging system 2 cooperates with an integrated circuit 1. The debugging system 2 and the integrated circuit 1 may be included in one electronic device practically, such as a PC or a notebook computer.

The integrated circuit 1 may be any integrated circuit chip in the electronic device. The integrated circuit 1 includes a plurality of circuit blocks and each of them has a different function, such as calculating, controlling or temporary storing. When the integrated circuit 1 operates, the integrated circuit 1 may happen some error events, such as a cyclic redundancy code (CRC) error, which are needed to find out the reasons and the location of the error events by a debugging mechanism.

The debugging system 2 includes a transmission interface 20, a debugging trigger multiplexer 22, a debugging signal multiplexer 23, a buffer 24, and a differential signal converter 26.

The transmission interface 20 may be a Universal Serial Bus (USB) or a Peripheral Component Interconnect Express (PCIE). The transmission interface 20 has different communication protocols according to different types. However, the communication protocol may include a vendor defined packet which can be defined by users regardless of the type the transmission interface 20. Defined data can be transmitted via a packet and decoded by a corresponding packet decoder, and then outputted to a device connected with the transmission interface 20.

The debugging trigger multiplexer 22 is a multiplexer which is electrically connected with the integrated circuit 1. Users can program the debugging trigger multiplexer 22 to make the debugging trigger multiplexer 22 detect whether the error event happens and determine whether the error event is a specific type. If it is the error event with the specific type, a trigger signal is output. Additionally, after programming the debugging trigger multiplexer 22, users can manually choose the type of the error event to be detected. For example, the debugging trigger multiplexer 22 can be programmed to detect five types of the error event, but users can only implement the error event of detecting the CRC error and close other types, therefore, the debugging trigger multiplexer 22 only detects whether the integrated circuit has the CRC error. In other words, users can close all types of the error event after the debug process is finished, so as to reduce the extra power consumption of the debugging system 2.

The debugging signal multiplexer 23 is a multiplexer electrically connected with the integrated circuit 1. Users can program the debugging signal multiplexer 23. When the error event happens, a plurality of observing signals selected by the debugging signal multiplexer 23, such as forming an observing signals group, may be provided for debugging analyzing. For example, the programmed debugging signal multiplexer 23 may select observing signals from all signals of a circuit block which is responsible for the CRC operation in the integrated circuit 1. The observing signals may be used for debugging analyzing when the CRC error happens.

The buffer 24 is electrically connected with the debugging trigger multiplexer 22 and the debugging signal multiplexer 23. When the selected error event happens at a time point, the debugging trigger multiplexer 22 outputs a trigger signal, and the buffer 24 is triggered by the trigger signal to start operating. The buffer 24 stores the values of the observing signals received from the debugging signal multiplexer 23 at the time point and outputs an observing packet according to the observing signals. The buffer 24 may embed the values of the observing signals at the time point in the observing packet to output. By the operation of the buffer 24, the observing signals, which are a part of signals of the integrated circuit 1 at the time of the error event, can be recorded for debugging analyzing. The differential signal converter 26 is coupled with the buffer 24 and electrically connected with the transmission interface 20. The differential signal converter 26 is used for converting the observing packet output by the buffer 24 to differential voltage signals and outputting the differential voltage signals via the transmission interface 20. The differential signal converter 26 encodes packets according to the type and specification of the transmission interface 20 and outputs the packets which are the differential voltage signals. During the debugging process, the differential signal converter 26 outputs a plurality of output signals according to the observing packet. That is to say, the differential signal converter 26 encodes the observing packet and outputs the output signals which are the differential voltage signals. The encoding scheme of the packet of the differential signal converter 26 is various along with the communication protocol of the transmission interface 20, which is not limited herein.

The debugging system 2 further includes an arbiter 25. The arbiter 25 is electrically connected with the integrated circuit 1, the buffer 24 and the differential signal converter 26. The arbiter 25 receives a plurality of data packets outputted by the integrated circuit 1 and the observing packet outputted by the buffer 24, and outputs these packets to the differential signal converter 26 according to a priority value table. Each type of packets has a priority value. The priority value differs depending upon the communication protocol of the transmission interface 20. Generally, the priority values of various packet types are based on predefined priority values of the communication protocol of the transmission interface 20, and they can be adjusted by users. For example, the priority value of data packets with the system operating information is higher than the priority value of the observing packet, however users can adjust the priority value of the observing packet to be higher than the priority value of data packets as needed, so that the observing packet can be outputted prior. Priority values of all the packets are gathered to generate the priority value table, and the arbiter 25 may determine the output sequence of the packets according to the priority value table. A display 3 and an external electronic device 4 may be electrically connected with the transmission interface 20. The display 3 is a signal analyzer used for analyzing signals of the transmission interface 20. Taking that the transmission interface is a PCIE interface as an example, the display 3 may be a PCIE analyzer which receives and decodes to display the output signals outputted by the transmission interface 20 for debugging analyzing. The external electronic device 4 has the same communication protocol with the transmission interface 20.

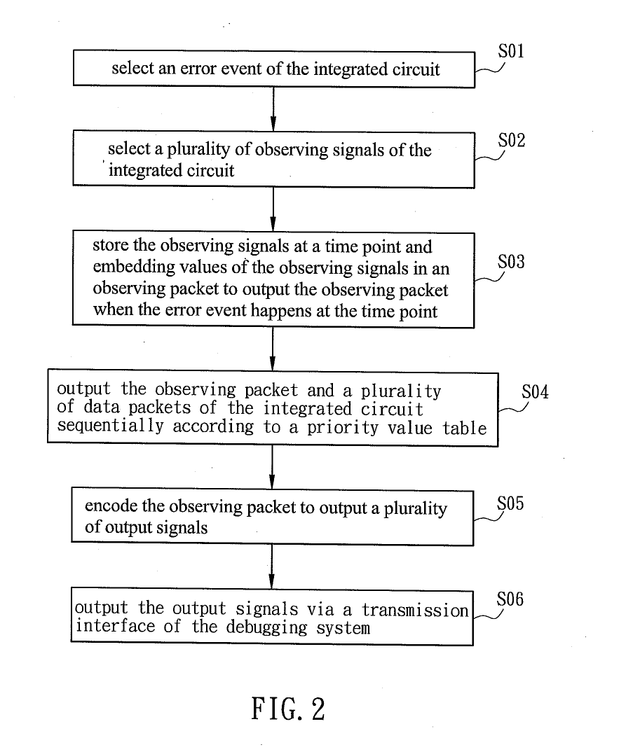

FIG. 2 is a flow chart showing a debugging method of an integrated circuit in an embodiment. The debugging method cooperates with an integrated circuit and a debugging system. Please refer to FIG. 1 and FIG. 2, the architectures of the integrated circuit 1 and the debugging system 2 are as that described above, which is omitted herein for concise purpose. The debugging method includes steps S01 to S07.

In step S01, selecting an error event of the integrated circuit by the debugging trigger multiplexer 22 to detect the integrated circuit 1 and determine whether the error event happens.

In step S02, selecting a plurality of observing signals of the integrated circuit by the debugging signal multiplexer 23 for subsequence debugging analyzing. The observing signals may be a part of internal signals of the integrated circuit 1. Furthermore, the observing signals are from the circuit block which is most likely to have the error event. For example, the circuit block may be determined according to a statistical result of the error event happened in each circuit block in the history records, and it also may be defined by users, which is not limited herein.

In step S03, when the error event happens in the integrated circuit 1 at a time point, once the debugging trigger multiplexer 22 detects the error event happens in the integrated circuit 1, and it outputs a trigger signal to trigger the buffer 24 to start operating. The butter 24 stores the values of the observing signals at the time point and embeds the stored observing signals in an observing packet to output the observing packet.

In step S04, the arbiter 25 sequentially outputs the observing packet of the buffer 24 and a plurality of data packets received by the integrated circuit to the differential signal converter 26 according to a priority value table, and the setting of the priority value table is as described above, which is omitted herein.

In step S05, the differential signal converter 26 outputs a plurality of output signals according to the observing packet. Furthermore, the differential signal converter 26 encodes the received packets according to the communication protocol of the transmission interface 20 to convert the received packets to the differential voltage signals, so the differential signal converter 26 is not limited to be used for only converting the observing packet.

In step S06, the output signals are outputted by the transmission interface 20 for debugging analyzing.

Furthermore, the debugging analysis can be more effective when the display 3 connected with the transmission interface 20 captures, decodes, and displays the output signals.

The debugging method also may include that defining a plurality of vendor defined packets according to the communication protocol of the transmission interface, and the observing packet may be one of the vendor defined packets. Detailed steps of the debugging method have been described above and will not be described herein, but they are included in the scope of the embodiment.

Although the present disclosure has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A debugging system of an integrated circuit, applied to the integrated circuit, the debugging system comprising:
a debugging trigger multiplexer electrically connected with the integrated circuit to detect an error event of the integrated circuit;
a debugging signal multiplexer electrically connected with the integrated circuit to detect the error event of the integrated circuit, choosing and outputting a plurality of observing signals according to the error event;
a buffer electrically connected with the debugging trigger multiplexer and the debugging signal multiplexer to receive the observing signals;
a differential signal converter coupled with the buffer; and
a transmission interface electrically connected with the differential signal converter.

2. The debugging system of the integrated circuit according to claim 1, wherein the buffer stores values of the observing signals at a time point and embeds the values of the observing signals in an observing packet to output the observing packet.

3. The debugging system of the integrated circuit according to claim 2, wherein when the error event happens at the time point, the debugging trigger multiplexer outputs a trigger signal to the buffer to trigger the buffer to store the values of the observing signals at the time point.

4. The debugging system of the integrated circuit according to claim 2, wherein the differential signal converter encodes the observing packet and outputs a plurality of output signals to the transmission interface, and the transmission interface outputs the output signals.

5. The debugging system of the integrated circuit according to claim 3, further comprising:
an arbiter electrically connected with the integrated circuit, the buffer and the differential signal converter, wherein the arbiter sequentially outputs the observing packet and a plurality of data packets of the integrated circuit to the differential signal converter according to a priority value table.

6. The debugging system of the integrated circuit according to claim 4, wherein the output signals are differential voltage signals.

7. The debugging system of the integrated circuit according to claim 4, wherein the output signals are decoded and displayed by a display coupled with the transmission interface.

8. The debugging system of the integrated circuit according to claim 7, wherein the display is a signal analyzer of the transmission interface.

9. A debugging method of an integrated circuit, applied to an integrated circuit and a debugging system, the debugging method comprising:
selecting an error event of the integrated circuit;
selecting a plurality of observing signals of the integrated circuit;
storing values of the observing signals at a time point and embedding values of the observing signals in an observing packet to output the observing packet when the error event happening at the time point;
outputting the observing packet and a plurality of data packets of the integrated circuit sequentially according to a priority value table;
encoding the observing packet to output a plurality of output signals; and
outputting the output signals via a transmission interface of the debugging system.

10. The debugging method of the integrated circuit according to claim 9, wherein the output signals are differential voltage signals.
